(19) United States
(12) Patent Application Publication
(10) Pub. No.: US 2023/0028250 A1
(43) Pub. Date: Jan. 26, 2023

(54) OPTICAL SENSING APPARATUS

(71) Applicant: Egis Technology Inc., Hsinchu City (TW)

(72) Inventors: Yao-Sheng Hu, Hsinchu City (TW); Chin-An Hsieh, Hsinchu City (TW); Ching-Wei Chen, Hsinchu City (TW)

(73) Assignee: Egis Technology Inc., Hsinchu City (TW)

(21) Appl. No.: 17/750,420

(22) Filed: May 23, 2022

Related U.S. Application Data
(60) Provisional application No. 63/224,845, filed on Jul. 22, 2021.

(30) Foreign Application Priority Data
Mar. 31, 2022 (CN) 202210344266.2

(51) Int. Cl. G01J 1/44; G01S 17/08

(52) U.S. Cl. CPC G01J 1/44; G01S 17/08

(57) ABSTRACT

An optical sensing apparatus is provided. A bias-voltage generating circuit provides a first bias voltage and a second bias voltage to a photo-sensing diode when the optical sensing apparatus is respectively in a first mode and a second mode, such that the photo-sensing diode provides a time-of-flight ranging signal in the first mode and an ambient-light sensing signal in the second mode. A quenching circuit provides the time-of-flight ranging signal to a ranging signal processing circuit in the first mode, quenches the photo-sensing diode, and provides the ambient-light sensing signal to a light-sensing signal processing circuit in the second mode.

### CROSS-REFERENCE TO RELATED APPLICATION

This application claims the priority benefit of U.S. provisional application Ser. No. 63/224,845, filed on Jul. 22, 2021 and China application serial no. 202210344266.2, filed on Mar. 31, 2022. The entirety of each of the above-mentioned patent applications is hereby incorporated by reference herein and made a part of this specification.

### BACKGROUND

### Technical Field

The present disclosure relates to a sensing apparatus, particularly to an optical sensing apparatus.

### Description of Related Art

Integrated chips (ICs) with photonic devices are in many modern electronic devices. For example, photonic devices including image sensors are used in photography systems such as cameras and video recorders to capture images. Photonic devices are also widely used in other applications, such as depth sensors. Depth sensors in a time-of-flight (TOF) system are used to determine the distance between the sensor and the target object. Depth sensors in TOF systems may also be used in smartphones (for facial recognition and camera focusing, for example), cars, drones, robots, etc.

Conventionally, two different photosensitive diodes, i.e., the single-photon avalanche diode and the ambient photo-sensing diode, and their circuits are all placed on the same wafer as a way to integrate the TOF chip and the ambient light sensing chip. As the two different photosensitive diodes each occupy a large circuit area, such way of integration costs significantly in terms of manufacturing.

### SUMMARY

The disclosure provides an optical sensing apparatus capable of reducing substantially the circuit area and the manufacturing cost thereof.

The optical sensing apparatus of the disclosure includes a bias-voltage generating circuit, a photo-sensing diode, and a quenching circuit. The bias-voltage generating circuit provides a first bias voltage when the optical sensing apparatus is in a first mode, and provides a second bias voltage when the optical sensing apparatus is in a second mode. The photo-sensing diode has a cathode coupled to the bias-voltage generating circuit. The photo-sensing diode receives the first bias voltage to provide a time-of-flight ranging signal in the first mode, and receives the second bias voltage to provide an ambient-light sensing signal in the second mode. The quenching circuit is coupled to the anode of the photo-sensing diode. The quenching circuit provides the time-of-flight ranging signal to a ranging signal processing circuit in the first mode, quenches the photo-sensing diode, and provides the ambient-light sensing signal to the light-sensing signal processing circuit in the second mode.

Based on the above, in the embodiment of the disclosure, the bias-voltage generating circuit respectively provides the first bias voltage and the second bias voltage to the photo-sensing diode when the optical sensing apparatus is respectively in the first mode and the second mode, such that the photo-sensing diode may respectively provide the time-of-flight ranging signal and the ambient-light sensing signal; and the quenching circuit provides the time-of-flight ranging signal to the ranging signal processing circuit in the first mode, quenches the photo-sensing diode, and provides the ambient-light sensing signal to the light-sensing signal processing circuit in the second mode. By providing different bias voltages to the photo-sensing diode in different modes, the photo-sensing diode may be adapted for time-of-flight ranging or ambient light sensing in different modes. With a shared photo-sensing diode, the circuit area and/or the manufacturing cost of the photo-sensing apparatus may be reduced.

### BRIEF DESCRIPTION OF THE DRAWING

FIG. 1 is a schematic diagram of an optical sensing apparatus according to an embodiment of the disclosure.

FIG. 2 is a schematic diagram of an optical sensing apparatus according to another embodiment of the disclosure.

FIG. 3 is a schematic diagram of a buffer amplifier according to an embodiment of the disclosure.

FIG. 4 is a schematic diagram of an optical sensing apparatus according to yet another embodiment of the disclosure.

FIG. 5 is a schematic diagram of an optical sensing apparatus according to still another embodiment of the disclosure.

FIG. 6 is a schematic diagram of an analog-to-digital conversion circuit according to an embodiment of the disclosure.

### DESCRIPTION OF THE EMBODIMENTS

To make the content of the disclosure more comprehensible, the following embodiments are taken as examples by which the disclosure can indeed be implemented. Additionally, where possible, elements/components/steps using the same reference numerals in the drawings and embodiments represent the same or similar parts.

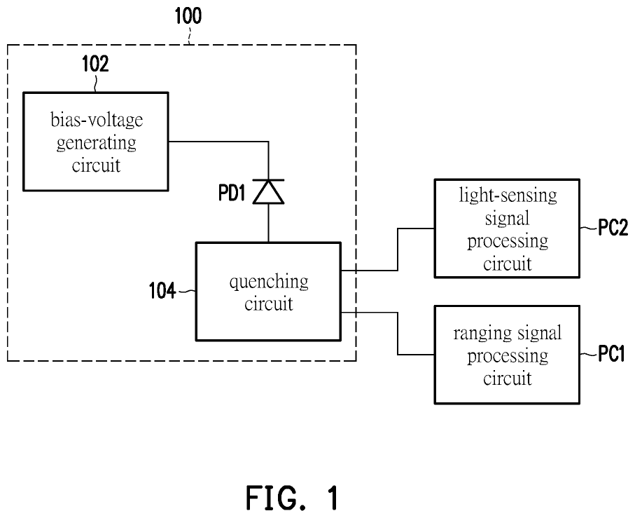

Please refer to FIG. 1 below. FIG. 1 is a schematic diagram of an optical sensing apparatus according to an embodiment of the disclosure. The optical sensing apparatus 100 may include a bias-voltage generating circuit 102, a photo-sensing diode PD1, and a quenching circuit 104. The bias-voltage generating circuit 102 is coupled to the cathode of the photo-sensing diode PD1, and the quenching circuit 104 is coupled to the anode of the photo-sensing diode PD1. The quenching circuit 104 may be active or passive, to which the disclosure is not limited. The bias-voltage generating circuit 102 provides a first bias voltage to the photo-sensing diode PD1 when the optical sensing apparatus 100 is in the first mode, and provides a second bias voltage to the photo-sensing diode PD1 when the optical sensing apparatus 100 is in the second mode, such that the photo-sensing diode PD1 may be adapted for different sensing in the first mode and the second mode.

For example, in the first mode, the bias-voltage generating circuit 102 generates a first bias voltage greater than the breakdown voltage of the photo-sensing diode PD1, such that the photo-sensing diode PD1 enters an extremely reverse biased state. In this way, when a photon is injected into the depletion layer of the photo-sensing diode PD1, the photo-sensing diode PD1 may be triggered to generate an avalanche current, thereby providing a time-of-flight ranging signal for time-of-flight measurement. In the second mode, the bias-voltage generating circuit 102 generates a second bias voltage with a voltage value smaller than the first bias voltage (3.3V or 1.6V, for example, to which the disclosure is not limited; it may be at any voltage value as long as the depletion layer of the photo-sensing diode PD1 can capture photons), and the photo-sensing diode PD1 receives the second bias voltage to be in a reverse bias state and generates a photocurrent in response to the photons captured by the depletion layer to provide an ambient-light sensing signal for ambient light sensing.

The quenching circuit 104 outputs the time-of-flight ranging signal provided by the photo-sensing diode PD1 to the ranging signal processing circuit PC1 coupled to the quenching circuit 104 in the first mode, quenches the photo-sensing diode PD1, such that the ranging signal processing circuit PC1 obtains the round-trip time between the light source and the target object of the light provided by a light source (not shown) based on the time-of-flight ranging signal, and calculates the distance between the light source and the object based on the round-trip time. The quenching circuit 104 outputs the ambient-light sensing signal provided by the photo-sensing diode PD1 to the light-sensing signal processing circuit PC2 coupled to the quenching circuit 104 in the second mode, such that the light-sensing signal processing circuit PC2 may obtain ambient light information (e.g., ambient light intensity, to which the disclosure is not limited) according to the ambient-light sensing signal. In this embodiment, the ambient-light sensing signal provided by the photo-sensing diode PD1 is directly output to the light-sensing signal processing circuit PC2, whereas in other embodiments, the quenching circuit 104 and the light-sensing signal processing circuit PC2 may further include other signal processing circuits. For example, the ambient-light sensing signal provided by the photo-sensing diode PD1 may also be output to the light-sensing signal processing circuit PC2 through an analog-to-digital conversion circuit.

By providing different bias voltages to the photo-sensing diode PD1 in different modes, the photo-sensing diode PD1 may be adapted for time-of-flight ranging or ambient light sensing in different modes. With the shared photo-sensing diode PD1, the circuit area and/or the manufacturing cost of the photo-sensing apparatus 100 may be reduced.

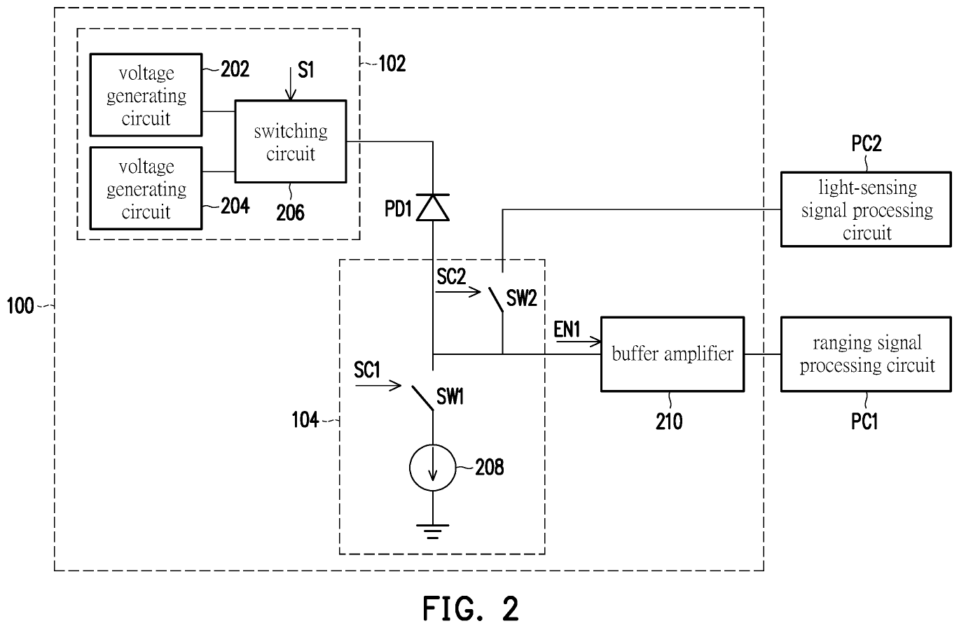

FIG. 2 is a schematic diagram of an optical sensing apparatus according to another embodiment of the disclosure. In this embodiment, the bias-voltage generating circuit 102 may include a voltage generating circuit 202, a voltage generating circuit 204, and a switching circuit 206, and the quenching circuit 104 may include a bias current source 208, a switch SW1, and a switch SW2. In addition, the optical sensing apparatus 100 may further include a buffer amplifier 210. The switching circuit 206 is coupled to the voltage generating circuits 202 and 204 and the cathode of the photo-sensing diode PD1. The switch SW1 is coupled to the anode of the photo-sensing diode PD1 and the bias current source 208, and the switch SW2 is coupled to the anode of the photo-sensing diode PD1 and the light-sensing signal processing circuit PC2. The bias current source 208 may be implemented by, for example, a transistor controlled by a bias voltage, but the disclosure is not limited thereto. In addition, the buffer amplifier is coupled between the anode of the photo-sensing diode PD1 and the ranging signal processing circuit PC1.

The voltage generating circuit 202 generates a first bias voltage, and the voltage generating circuit 204 generates a second bias voltage. The switching circuit 206 is controlled by a switching control signal Si, such that the voltage generating circuit 202 is connected to the cathode of the photo-sensing diode PD1 in the first mode to provide a first bias voltage to the cathode of the photo-sensing diode PD1, and the voltage generating circuit 204 is connected to the cathode of the photo-sensing diode PD1 in the second mode to provide a second bias voltage to the cathode of the photo-sensing diode PD1.

In the first mode, the switch SW1 is controlled by the switch control signal SC1 to be turned on, whereas the switch SW2 is controlled by the switch control signal SC2 to be turned off. In this way, when the photo-sensing diode PD1 generates a breakdown current in the first mode, the breakdown current flowing through the switch SW1 and the bias current source 208 increases the voltage of the anode of the photo-sensing diode PD1, thereby quenching the photo-sensing diode PD1, and the voltage of the anode of the photo-sensing diode PD1 returns to the original voltage (e.g., the ground voltage of the present embodiment) as the photo-sensing diode PD1 is turned off. The buffer amplifier 210 is controlled by the enable control signal EN1 to be in an enabled state in the first mode. The buffer amplifier 210 buffers and amplifies the time-of-flight ranging signal provided by the photo-sensing diode PD1, and transmits the time-of-flight ranging signal to the ranging signal processing circuit PC1. In addition, in the second mode, the switch SW1 is controlled by the switch control signal SC1 to be in the off state, the switch SW2 is controlled by the switch control signal SC2 to be in the on state, and the buffer amplifier 210 is controlled by the enable control signal EN1 to be in a disabled state. In this way, the light-sensing signal processing circuit PC2 may receive the ambient-light sensing signal provided by the photo-sensing diode PD1 in the second mode.

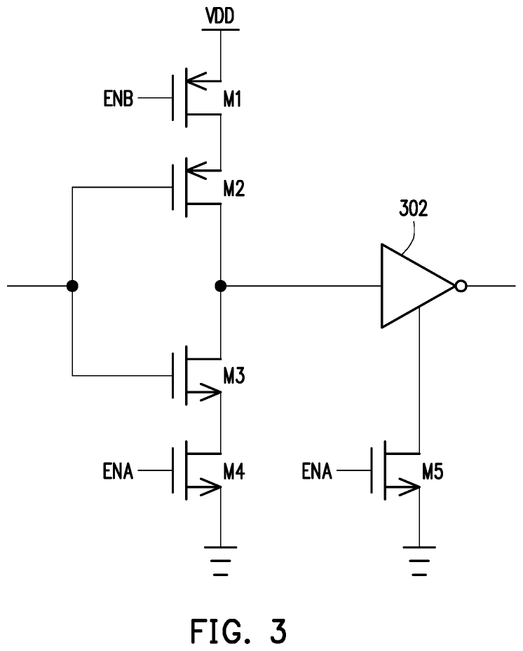

As shown the embodiment of FIG. 3, a buffer amplifier 210 may include transistors M1 to M5 and an inverter 302. In this embodiment, the enable control signal EN1 may include the enable control signals ENA and ENB. The transistors M1 and M2 are coupled between the operating voltage VDD and the input end of the inverter 302. The transistors M3 and M4 are connected in series between the input end of the inverter 302 and the ground voltage. The control ends of the transistors M1 and M4 respectively receive the enable control signals ENB and ENA. The control ends of the transistors M2 and M3 are coupled to the anode of the photo-sensing diode PD1. The transistor M5 is coupled between the power supply end of the inverter 302 and the ground voltage, and the control end of the transistor M5 receives the enable control signal ENA. The output end of the inverter 302 is coupled to the ranging signal processing circuit PC1. The transistors M1, M4, and M5 may be controlled by the enable control signals ENA and ENB, such that the buffer amplifier 210 is enabled in the first mode and disabled in the second mode.

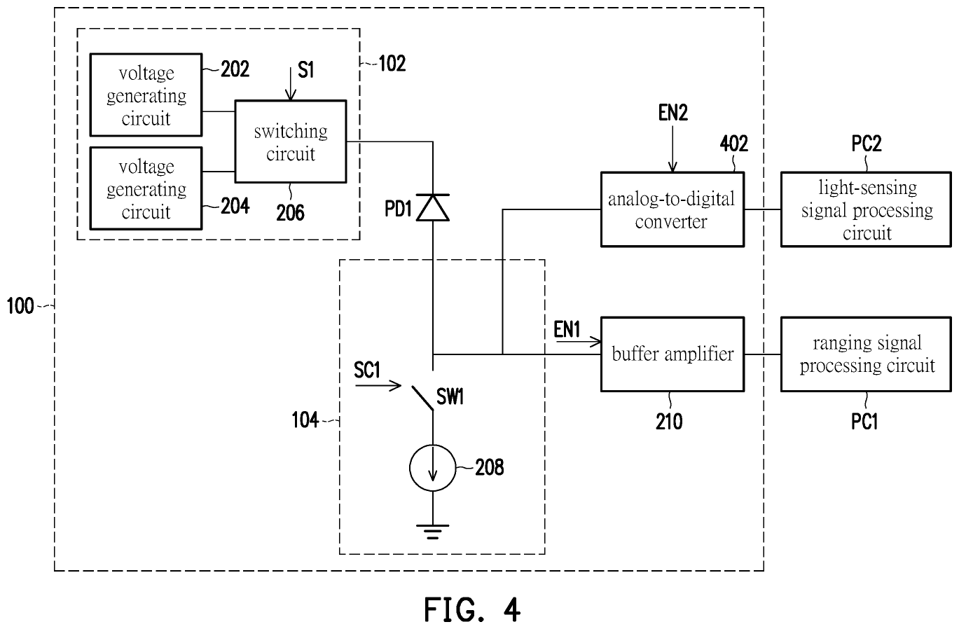

FIG. 4 is a schematic diagram of an optical sensing apparatus according to yet another embodiment of the disclosure. Compared with the embodiment of FIG. 2, the quenching circuit 104 of this embodiment does not include the switch SW2 but further includes an analog-to-digital conversion circuit 402. The analog-to-digital conversion circuit 402 is coupled to the anode of the photo-sensing diode PD1. In the first mode, the analog-to-digital conversion circuit 402 may be disabled by the enable control signal EN2, and the buffer amplifier 210 is controlled by the enable control signal EN1 to be enabled, such that the time-of-flight ranging signal may be transmitted to the ranging signal processing circuit PC1 through the buffer amplifier 210. In the second mode, the analog-to-digital conversion circuit 402 is enabled by the enable control signal EN2, and the buffer amplifier 210 is controlled by the enable control signal EN1 to be disabled, such that the analog-to-digital conversion circuit 402 converts the ambient-light sensing signal provided by the photo-sensing diode PD1 into a digital signal and transmits the same to the light-sensing signal processing circuit PC2. Compared with the embodiment of FIG. 2, the quenching circuit 104 is simplified in this embodiment.

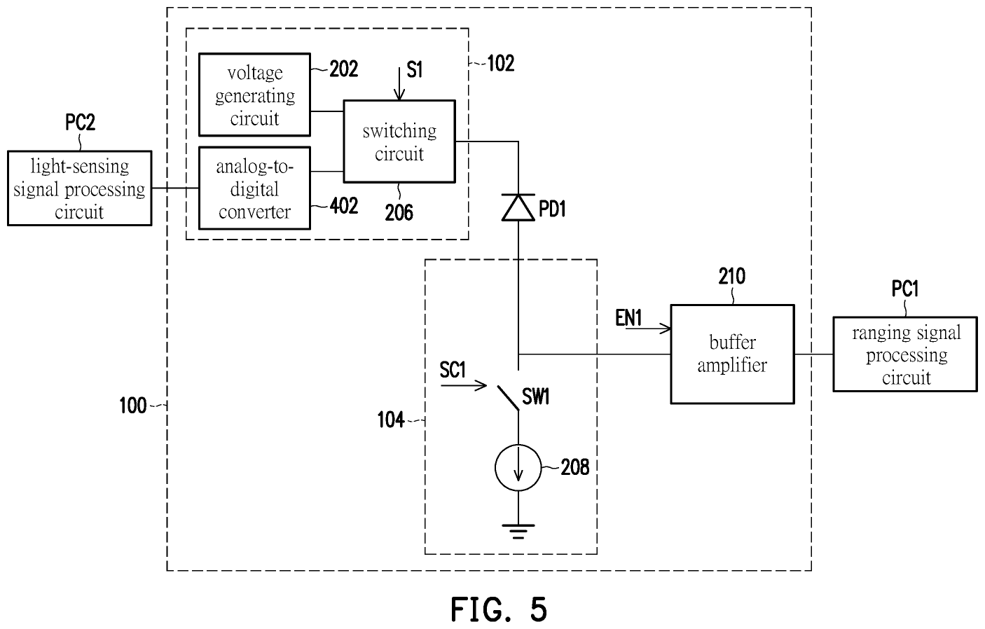

FIG. 5 is a schematic diagram of an optical sensing apparatus according to still another embodiment of the disclosure. Compared with the embodiment of FIG. 4, the analog-to-digital conversion circuit 402 of the present embodiment may be integrated into the bias-voltage generating circuit 102 and replace the voltage generating circuit 204. The analog-to-digital conversion circuit 402 is coupled to the switching circuit 206 and the light-sensing signal processing circuit PC2. The analog-to-digital conversion circuit 402 is a replacement of the function of the voltage generating circuit 204, that is, providing the second bias voltage. In the first mode, the switching circuit 206 is controlled by the switching control signal Si to connect the voltage generating circuit 202 to the anode of the photo-sensing diode PD1 to provide the first bias voltage generated by the voltage generating circuit 202 to the cathode of the photo-sensing diode PD1. In the second mode, the switching circuit 206 is controlled by the switching control signal Si to connect the analog-to-digital conversion circuit 402 to the anode of the photo-sensing diode PD1 to provide the second bias voltage to the cathode of the photo-sensing diode PD1.

Similarly, in the first mode, the time-of-flight ranging signal provided by the photo-sensing diode PD1 may be provided to the ranging signal processing circuit PC1 through the buffer amplifier 210, and the quenching circuit 104 would also quench the photo-sensing diode PD1. In the second mode, the switch SW1 is in an off state, and the buffer amplifier 210 is in a disabled state. The analog-to-digital conversion circuit 402 receives the ambient-light sensing signal provided by the photo-sensing diode PD1 through the switching circuit 206, converts the ambient-light sensing signal into a digital signal, and then provide the digital signal to the light-sensing signal processing circuit PC2.

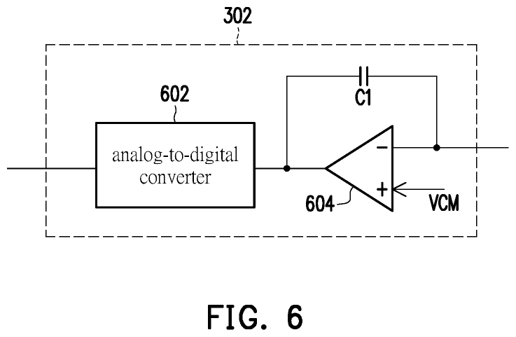

Furthermore, the analog-to-digital conversion circuit 402 may, for example, include an analog-to-digital converter 602, an operational amplifier 604, and a capacitor C1 as shown in FIG. 6. The analog-to-digital converter 602 is coupled to the output end of the light-sensing signal processing circuit PC2 and the operational amplifier 604. The capacitor C1 is coupled between the output end and the negative input end of the operational amplifier 604. The negative input end of the operational amplifier 604 is coupled to the switching circuit 206. The positive input end of the operational amplifier 604 is coupled to a second bias voltage VCM. Thus, in the second mode, by virtue of the virtual short-circuit characteristic between the positive and negative input ends of the operational amplifier 604, the analog-to-digital conversion circuit 402 can provide the second bias voltage VCM to the photo-sensing diode PD1 through the switching circuit 206, and receive the ambient-light sensing signal from the photo-sensing diode PD1. The ambient-light sensing signal may be converted into a digital signal by the analog-to-digital converter 602 before being provided to the light-sensing signal processing circuit PC2.

In summary, in the embodiment of the disclosure, the bias-voltage generating circuit respectively provides the first bias voltage and the second bias voltage to the photo-sensing diode when the optical sensing apparatus is respectively in the first mode and the second mode, such that the photo-sensing diode may respectively provide the time-of-flight ranging signal and the ambient-light sensing signal; and the quenching circuit provides the time-of-flight ranging signal to the ranging signal processing circuit in the first mode, quenches the photo-sensing diode, and provides the ambient-light sensing signal to the light-sensing signal processing circuit in the second mode. By providing different bias voltages to the photo-sensing diode in different modes, the photo-sensing diode may be adapted for time-of-flight ranging or ambient light sensing in different modes. With a shared photo-sensing diode, the circuit area and/or the manufacturing cost of the photo-sensing apparatus may be reduced.

Although the disclosure has been disclosed by the embodiments above, it is not intended to limit the disclosure. Anyone with ordinary knowledge in the technical field can make changes and modifications without departing from the spirit and scope of the disclosure. Therefore, the protection scope of the disclosure shall be determined by the scope of the claims attached.

What is claimed is:

1. An optical sensing apparatus, comprising:
a bias-voltage generating circuit, adapted to provide a first bias voltage when the optical sensing apparatus is in a first mode, and provide a second bias voltage when the optical sensing apparatus is in a second mode;
a photo-sensing diode, having a cathode coupled to the bias-voltage generating circuit, adapted to receive the first bias voltage to provide a time-of-flight ranging signal in the first mode and receive the second bias voltage to provide an ambient-light sensing signal in the second mode; and
a quenching circuit, coupled to an anode of the photo-sensing diode, adapted to provide the time-of-flight ranging signal to a ranging signal processing circuit in the first mode, quench the photo-sensing diode, and provide the ambient-light sensing signal to a light-sensing signal processing circuit in the second mode.

2. The optical sensing apparatus as claimed in claim 1, wherein the quenching circuit comprises:
a first switch, coupled to the anode of the photo-sensing diode; and
a bias current source, coupled between the first switch and a reference voltage, wherein the first switch is controlled by a first switch control signal to be turned on in the first mode and turned off in the second mode.

3. The optical sensing apparatus as claimed in claim 2, further comprising:
an analog-to-digital conversion circuit, coupled to the anode of the photo-sensing diode, and adapted to convert the ambient-light sensing signal into a digital signal and provide the digital signal to the light-sensing signal processing circuit.

4. The optical sensing apparatus as claimed in claim 3, wherein the quenching circuit further comprises:
a second switch, coupled between the anode of the photo-sensing diode and the analog-to-digital conversion circuit, and controlled by a second switch control signal to be turned off in the first mode and turned on in the second mode.

5. The optical sensing apparatus as claimed in claim 3, wherein the analog-to-digital conversion circuit is further controlled by an enable control signal to be disabled in the first mode and enabled in the second mode.

6. The optical sensing apparatus as claimed in claim 1, wherein the bias-voltage generating circuit comprises:
a switching circuit, coupled to the anode of the photo-sensing diode;
a first voltage generating circuit, coupled to the switching circuit to generate the first bias voltage; and
a second voltage generating circuit, coupled to the switching circuit to generate the second bias voltage, wherein the switching circuit is controlled by a switching control signal to switch the anode of the photo-sensing diode to be connected to the first voltage generating circuit in the first mode and to switch the anode of the photo-sensing diode to be connected to the second voltage generating circuit in the second mode.

7. The optical sensing apparatus as claimed in claim 1, wherein the bias-voltage generating circuit comprises:
a switching circuit, coupled to the cathode of the photo-sensing diode;
a voltage generating circuit, coupled to the switching circuit to generate the first bias voltage; and
an analog-to-digital conversion circuit, coupled to the switching circuit, adapted to generate the second bias voltage, convert the ambient-light sensing signal into a digital signal, and provide the digital signal to the light-sensing signal processing circuit,
wherein the switching circuit is controlled by a switching control signal to switch the anode of the photo-sensing diode to be connected to the first voltage generating circuit in the first mode, and to switch the anode of the photo-sensing diode to be connected to the second voltage generating circuit in the second mode.

8. The optical sensing apparatus as claimed in claim 7, wherein the analog-to-digital conversion circuit comprises:
an operational amplifier, having a positive input end coupled to the second bias voltage and a negative input end coupled to the switching circuit;
a capacitor, coupled between the negative input end and an output end of the operational amplifier; and
an analog-to-digital converter, having an input end and an output end respectively coupled to the output end of the operational amplifier and the light-sensing signal processing circuit.

9. The optical sensing apparatus as claimed in claim 1, further comprising:
a buffer amplifier, coupled to the cathode of the photo-sensing diode and the ranging signal processing circuit, adapted for the time-of-flight ranging signal, and controlled by an enable control signal to be enabled in the first mode and disabled in the second mode.

10. The optical sensing apparatus as claimed in claim 9, wherein the buffer amplifier comprises:
a first transistor;
a second transistor;
a third transistor;
a fourth transistor;
a fifth transistor; and
an inverter, wherein the first transistor and the second transistor are coupled between an operating voltage and an input end of the inverter, the third transistor and the fourth transistor are connected in series between the input end of the inverter and a ground voltage, the enable control signal comprises a first enable control signal and a second enable control signal, control ends of the fourth transistor and the first transistor respectively receive the first enable control signal and the second enable control signal, control ends of the second transistor and the third transistor are coupled to the anode of the photo-sensing diode, the fifth transistor is coupled between a power supply end of the inverter and the ground voltage, a control end of the fifth transistor receives the first enable control signal, and the first transistor, the fourth transistor, and the fifth transistor are controlled by the first enable control signal and the second enable control signal, such that the buffer amplifier is enabled in the first mode enabled and disabled in the second mode.
